(19) United States
(12) Patent Application Publication
(10) Pub. No.: US 2007/0048694 A1
(43) Pub. Date: Mar. 1, 2007

(54) System and method for simultaneous demonstration mouth movements together with visual presentation of an image that represents a letter(s) or word(s) being pronounced

(76) Inventor: Daniel A. Tepper, Easton, MD (US)

Correspondence Address: BACON & THOMAS, PLLC, 625 SLATERS LANE, FOURTH FLOOR, ALEXANDRIA, VA, 22314, US

(21) Appl. No.: 11/203,372

(22) Filed: Aug. 15, 2005

(51) Int. Cl. G09B 19/00

(52) U.S. Cl. 434/156

(57) ABSTRACT

A system and method for enabling simultaneous visualization of mouth movements and the letters or words being pronounced utilizes a series of flashcards, each containing on at least a first side of the card a representation of a letter or word, and each including a through hole shaped to enable an observer viewing the first side of the card to view the mouth of an instructor through the hole, while the card masks a portions of the instructor's face in order to focus the observer's attention on movements of the instructor's mouth as the instructor pronounces the letter or word represented on the first face of the card.

### BACKGROUND OF THE INVENTION

1. Field of the Invention

This invention relates to flashcards of the type currently used to teach or reinforce reading skills, namely cards that include images, such as letters, words, symbols, or phrases to be learned, and that further is arranged to facilitate visualization of mouth movements associated with, the letters, words, symbols or phrases.

In particular, the invention relates to flashcards including apertures that are approximately the size of a human mouth and positioned such that when the flashcard is held up to a face, the flashcard covers a substantial part of the face, with the mouth being visible through the aperture such that a viewer will simultaneously see the image together with movements of the speaker's mouth during pronunciation of the letter(s) or word(s) represented by the image included on the face of the flashcard. The cards not only can be used to teach reading to young children, but also as part of a language training or speech therapy program.

2. Description of Related Art

In order to learn the sounds associated with printed letters or words as part of a program of reading instruction, or correct pronunciation of the letters or words as part of a language instruction or speech therapy program, it is helpful to observe the mouth movements or positions associated with pronunciation of the letters or words, including lip and/or tongue movements and positions. Traditionally, a reading or language instructor, or speech therapist, will pronounce the letters or words while holding-up, or pointing to, a visual representation of the letters or words being pronounced. The representation may be in the form of written letters or words, or in the form of pictures or objects.

In order to benefit from this teaching method, it is necessary for the observer to integrate the static image of the letter or word and the dynamic image of the instructor's mouth, so that when the observer wishes to pronounce the letter or word, either immediately or at a later time, an accurate image of the instructor's mouth will also be recalled. However, static and dynamic images, and images of human faces and symbols, are processed and stored by the human brain in different ways, and therefore most individuals are unable to mentally combine or associate the disparate images in a way that enables simultaneous recall, unless part of a single original image, i.e., unless the static symbols and dynamic images are temporally and spatially integrated while being viewed.

Furthermore, humans have a tendency, when listening to a speaker, to concentrate on the speaker's eyes or other facial features and not on the mouth. Most persons can easily recall a person's overall face, but not individual features of the face. For example, it is essentially impossible to identify a person based just on an image of the person's mouth, unless the eyes and nose are also shown. No matter how hard an observer might try, it extremely difficult to stay focused for an extended period on just the mouth.

To solve these problems, it has been proposed to provide video, computer-generated, or other audio-visual representations of disembodied lip positions that can be displayed together with written or graphic images of the letters or words being pronounced. For example, U.S. Pat. No. 5,286,205 discloses a method of teaching spoken English that relies on display, on a television screen, of mouth positions and written words simultaneously with aural presentation of the words. U.S. Pat. No. 5,530,560 describes a similar language training system, but with speech analysis for providing feedback to the student.

Such audio visual systems have a number of disadvantages. Most require isolation of the student, and therefore are not suitable for classroom use. In addition, computer programs that employ speech recognition are, at present, costly and relatively difficult to implement, and are especially impractical for young children who require constant monitoring and assistance by a teacher. While televised images can hold an individual's attention, the attention is not as complete as it is with a live teacher, and students therefore tend to be more from a live teacher than a televised image. Computerized feedback cannot yet come close to matching that provided by a human teacher.

In order to optimize reading or language instruction, or speech therapy, it would therefore be desirable to integrate static images or letters or words with dynamic images of an actual human mouth. Furthermore, it is desirable to do so without the need for computing or audio visual equipment.

To accomplish this, the present invention adapts a concept of the inventor's that was first embodied in the book “Look Who's Talking,” Random House, New York (2005). “Look Who's Talking” is a children's picture book having oval cut-outs which, if positioned in front of the reader's mouth, enables the audience to view the mouth through the cut-out. The cut-out is positioned relative to illustrations of animals in such a way that the reader's mouth corresponds to the mouth of the animal. When the reader speaks, it appears that the animal is moving its mouth and actually speaking.

“Look Who's Talking” is solely for the entertainment. However, the present invention adapts this concept to language training and speech therapy, not only for young children, but also for adults.

### SUMMARY OF THE INVENTION

It is accordingly a first objective of the invention to provide a system and method of reading or language instruction, or speech therapy, that places a static image of a letter or word in spatial and temporal proximity with actual mouth movements of a human speaker, in order to enable an observer to more easily associate the mouth movements with the static image.

It is a second objective of the invention to provide an instructional object that focuses an observer's attention on a speaker's mouth, while eliminating distractions such as the user's eyes and other facial features, further enhancing the observer's ability to recall movements of the mouth.

It is a still further objective of the invention to provide a system and method for teaching pronunciation that is inexpensive and that can be implemented in home as well as formal educational settings, by parents as well as professional language teachers and instructors, and that is suitable for both adults and children, including pre-schoolers, toddlers, and even infants.

These objectives are achieved, in accordance with the principles of a preferred embodiment of the invention by a system and method for teaching reading or language, or for speech therapy, that utilizes a series of flashcards, each containing on at least a first side of the card a representation of a letter or word, and each including a through hole shaped to enable an observer viewing the first side of the card to view the mouth of an instructor through the hole, while the card masks portions of the instructor's face in order to focus the observer's attention on movements of the instructor's mouth as the instructor pronounces the letter or word represented on the first side of the card.

Although the invention is especially useful in teaching pronunciation, those skilled in the art will appreciate that the cards may also be used in place of ordinary flashcards as part of a reading instruction program where teaching pronunciation is not a primary objective. The image of the speaker pronouncing the letter or word will reinforce the student's recall of the sounds or meaning associated with the letter or word, or at the very least entertain the student and/or help keep the student from being distracted during the lesson.

### BRIEF DESCRIPTION OF THE DRAWINGS

FIG. 1 is a plan view of a first side of a card suitable for use in connection with the system and method of the present invention.

FIG. 2 is a plan view of a second side of the card of FIG. 1.

FIG. 3 is a flowchart of a language teaching method according to a preferred embodiment of the invention.

### DETAILED DESCRIPTION OF THE PREFERRED EMBODIMENTS

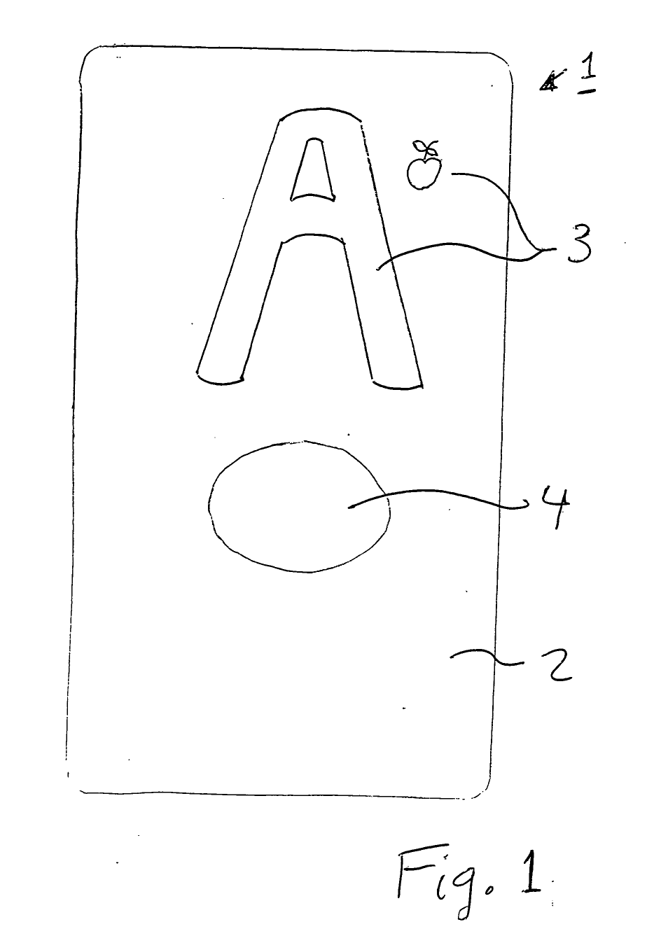

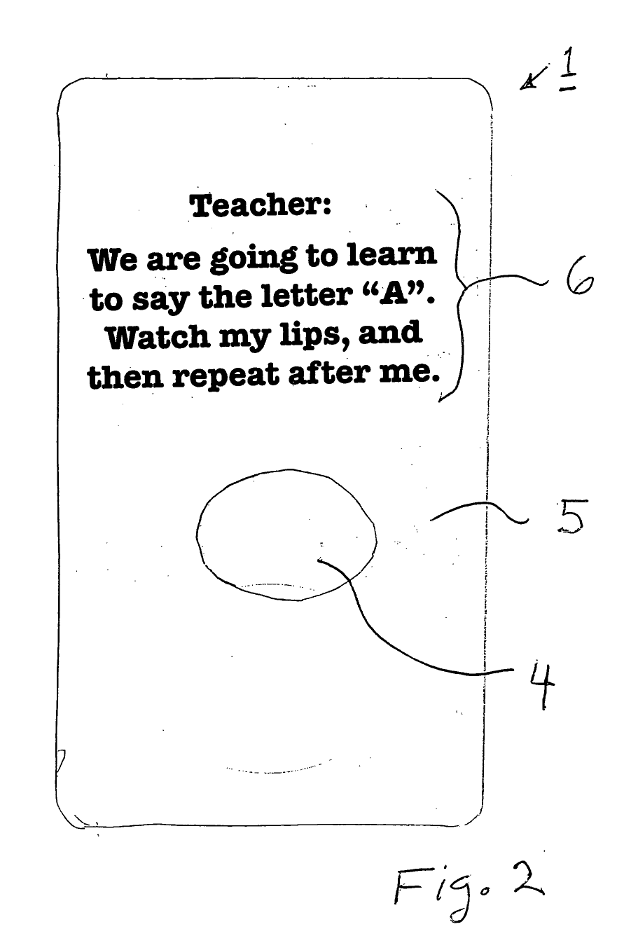

The system and method of the illustrated embodiment of the invention includes utilizes a plurality of cards, each configured in a manner similar to the flashcard illustrated in FIGS. 1 and 2. FIG. 1 shows a first side of the card and FIG. 2 illustrates a second side.

As shown in FIG. 1, the first side 2 of a preferred card 1 includes a representation 3 of a letter, letter combination, word, or phrase. The representation 3 may include printed letters or words to be pronounced, graphic depictions of objects (or actions) whose names are to be pronounced, or illustrations that indirectly represent sounds to be pronounced. For example, the card may simply depict the letter “p,” or a depiction of a pig to represent the letter “p.” For purposes of the invention, letters, letter combinations, words, phrases, syllables, phonemes, or any other units of speech, may be represented.

Those skilled in the art will appreciate that the flashcards of the invention may include any letters, words, symbols, and/or pictures included on conventional flashcards, and may be used for reading instruction in addition to language instruction or speech therapy. Furthermore, the images on the card may be printed, transferred, or applied to the card in any conventional fashion.

As illustrated in FIGS. 1 and 2, the card further includes a cut-out 4, which may alternatively be referred to as a through hole, aperture, or opening, having approximate dimensions of a human mouth, and through which the mouth of a speaker situated on an opposite side of the card from an observer is visible. For example, the cut out 4 may be in the shape of an oval having major and minor axes approximating the width and height of the human mouth. By way of example and not limitation, the major axis might be between 1.5 and 2 inches, and the minor axis between 1 and 1.5 inches. In addition to an oval, the cutout may by polygonal, or the cut out may even itself have a realistic or stylized mouth shape.

The overall dimensions of the card are preferably sufficiently large that the representation of the letter, letter combination, word, or phrase is visible to an intended audience. In addition, the card should preferably cover a significant portion of a speaker's face in order to isolate, in the observer's mind, the mouth of the speaker, i.e., in order to provide a partial disembodying effect so that the mouth's movements can be observed without distraction from the speaker's nose, eyes, and/or other facial features.

By way of example, and not limitation, the card may be rectangular in shape and have dimensions of between five and second inches, and a width of between 3.5 and five inches. These dimensions would at least be sufficient to cover most speaker's eyes and mouth. Larger dimensions could also be used, at the cost of portability and ease of manipulation. The shape does not need to be rectangular, and does not even need to be an abstract geometric shape, although a shape that is too interesting or realistic might distract from the speaker's mouth.

For reasons of cost and portability, the cards may be made of cardboard, optionally coated with a material such as wax or plastic that enhances the life of the card and protects the card from inadvertent exposure to the speaker's saliva or environmental damage. Those skilled in the art will appreciate that a wide variety of other materials may be used for the cards, and that the scope of the invention is not to be limited to a particular card material, shape, size, or method of manufacture, except as defined in the appended claims.

FIG. 2 shows a second side 5 of the card 1 of FIG. 1. As illustrated in this figure, the second side 5 of the card 1 includes instructions to the teacher in the form of a script 6 that may be read before pronouncing the letter, letter combination, word, or phrase. For example, the back of the card may contain the words “Teacher: We are going to learn to say the letter “A”. Watch my lips, and then repeat after me.” Such a script would be particularly useful if the cards are to be used by a non-professional teacher, such as a parent.

On the other hand, it is within the scope of the invention to provide a representation of a letter, letter combination, word, or phrase on the second side of the card. The representation may be the same as or different than the representation on the front of the card. If the representation is entirely different, than fewer numbers of cards would need to be provided for a given number of letters, letter combinations, words, or phrases to be taught. On the other hand, one side of the card could include a letter or word, and the second side might include a picture associated with the letter or word, or the two sides of the card might include words in different languages. Finally, it is also within the scope of the invention to leave the second side of the card blank.

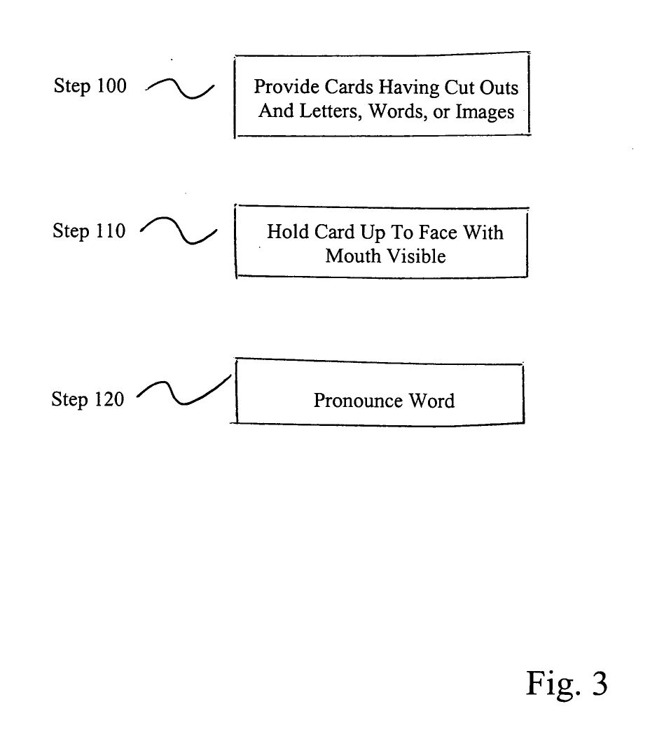

FIG. 3 illustrates a pronunciation teaching method according to the principles of the invention. The first step 100 of the method is of course to provide cards of the type described above in connection with FIGS. 1 and 2. In step 110, the instructor will then hold the card up to the face such that his or her mouth is visible through the cut-out. Finally, in step 110, the instructor will pronounce the letter, letter combination, word, or phrase represented on the front of the card. The observer can then observe the lip movements in conjunction with the representation of the letter, letter combination, word, or phrase, which will cause the observer to retain a composite mental image that combines the representation and the speaker's disembodied mouth.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention. As a result, it is intended that the invention not be limited by the above description or accompanying drawings, but that it be defined solely in accordance with the appended claims.

I claim:

1. A system for enabling simultaneous visualization of mouth movements and the letters or words being pronounced, comprising a series of flashcards, each containing on at least a first side of the card a representation of a letter or word, and each including a through hole shaped to enable an observer viewing the first side of the card to view the mouth of an instructor through the hole, while the card masks portions of the instructor's face in order to focus the observer's attention on movements of the instructor's mouth as the instructor pronounces the letter, letter combination, word, or phrase represented on the first face of the card.

2. A system as claimed in claim 1, wherein the representation of the letter, letter combination, or word includes the letter, letter combination, word, or phrase.

3. A system as claimed in claim 1, wherein the representation of the letter, letter combination, or word includes a graphic image.

4. A system as claimed in claim 1, wherein the through hole is an oval shaped cut-out having major and minor axis approximately equal to a width and height of a human mouth.

5. A system as claimed in claim 1, wherein the cards have dimensions large enough to cover at least a nose and eyes of a person when the person's mouth is visible through the through hole.

6. A system as claimed in claim 1, wherein the second side of the card includes instructions for an instructor.

7. A system as claimed in claim 6, wherein the second side of the card includes a script.

8. A method for enabling simultaneous visualization of mouth movements and the letters or words being pronounced, comprising the steps of:
providing a series of flashcards, each containing on at least a first side of the card a representation of a letter or word, and each including a through hole shaped to enable an observer viewing the first side of the card to view the mouth of an instructor through the hole, while the card masks portions of the instructor's face in order to focus the observer's attention on movements of the instructor's mouth as the instructor pronounces the letter or word represented on the first face of the card;
holding one of the cards up to the instructor's face such that the instructor's mouth is visible through the through hole; and
pronouncing the letter, combination of letters, or word represented on the first face for the card such that the instructor's lip movements are visible through the through hole.

9. A pronunciation teaching flashcard, comprising
a generally planar body having dimensions sufficient to cover a portion of an instructor's face;
a first surface having thereon a representation of a letter, letter combination, or word; and
a cutout having dimensions corresponding to a human mouth such that when the card is held up to the instructor's face and the portion of the instructor's face is hidden, an observer will see the representation of the letter, letter combination, and word together with the mouth of the instructor as the instructor pronounces the letter, letter combination, or word.
